(19) United States
(12) Patent Application Publication
(10) Pub. No.: US 2007/0296696 A1
(43) Pub. Date: Dec. 27, 2007

(54) Gesture exchange

(75) Inventor: Mikko Nurmi, Tampere (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/472,834

(22) Filed: Jun. 21, 2006

(51) Int. Cl. G09G 5/08

(52) U.S. Cl. 345/158

(57) ABSTRACT

A device including: an output device; a memory for storing first device movement data; a transmitter for sending to another communications device the first device movement data; a receiver for receiving second device movement data from the another communications device; and a processor operable to compare the stored first device movement data and the received second device movement data and to generate an output that depends upon the result of the comparison.

### FIELD OF THE INVENTION

Embodiments of the present invention relate to gesture exchange. In particular, they relate to a device, a method and a computer program that enable the use of an electronic device in gesture exchange.

### BACKGROUND TO THE INVENTION

Gesture exchange is a common social transaction that often occurs when people meet. One common example of gesture exchange is a hand-shake another is a ‘high-five’. These gesture exchanges involve physical contact. Other gesture exchanges such as hand waving or more complex hand gestures common in gang greetings do not involve physical contact.

It would be a desirable to somehow improve non-contact gesture exchange.

### BRIEF DESCRIPTION OF THE INVENTION

According to one embodiment of the invention there is provided a device comprising: an output device; a memory for storing first device movement data; a receiver for receiving second device movement data from another communications device; and a processor operable to compare the stored first device movement data and the received second device movement data and to generate an output that depends upon the result of the comparison.

The device may also comprise a transmitter for sending to the another communications device the first device movement data.

The output generated may be any function performable by an electronic device and may include any one or more of audio output, visual output, message transmission etc.

Audio output enables people to exchange gestures in a public and ostentatious manner.

Visual output enables people to exchange gestures in a private manner.

Message output allows other people, such as members of a social group who share a common signatory gesture, to be informed of an exchange of that gesture by members of the group. The message may also inform the members of the group of the location of the gesture exchange and identify the group members who made the exchange.

According to another embodiment of the invention there is provided a method comprising: storing first device movement data; receiving second device movement data; comparing the first device movement data and the second device movement data; and generating an output dependent upon the comparing step.

The method may also comprise transmitting the first device movement data.

According to another embodiment of the invention there is provided a computer program product comprising computer program instructions for: enabling storage of first device movement data; comparing the first device movement data with received second device movement data; and generating an output that depends upon the result of the comparison.

The computer program product may also enable transmission of the first device movement data.

### BRIEF DESCRIPTION OF THE DRAWINGS

For a better understanding of the present invention reference will now be made by way of example only to the accompanying drawings in which:

FIG. 1 schematically illustrates an electronic communications device;

FIG. 2 illustrates a first hand-portable communications device 10_{A} and a second hand-portable communications device 10_{B}; and

FIG. 3 illustrates a process that occurs at a communications device when movement data is received.

### DETAILED DESCRIPTION OF EMBODIMENTS OF THE INVENTION

The Figures illustrate a device 10 comprising: an output device 16; a memory 14 for storing 40 first device movement data 32; a transmitter 8 for sending to another communications device the first device movement data 32; a receiver 8 for receiving 42 second device movement data 36 from the another communications device; and a processor 12 operable to compare 44 the first device movement data 32 and the received second device movement data 36 and to generate 46 an output that depends upon the result of the comparison.

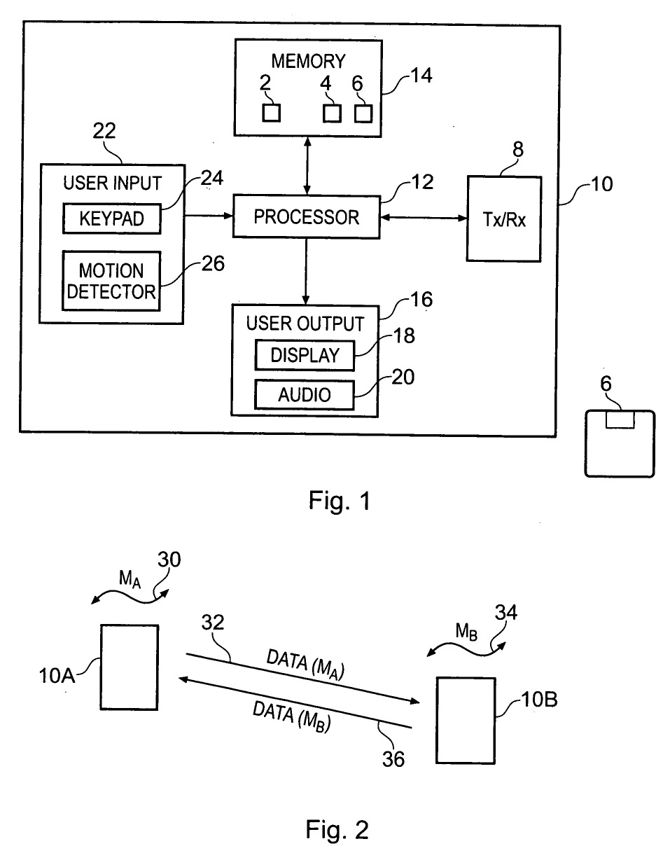

FIG. 1 schematically illustrates an electronic communications device 10 comprising: a processor 12, a memory 14, a user input interface 22, a user output interface 16 and a communications interface 8. In this example, the user input interface 22 comprises a user input device 24 such as a keypad or joystick and a motion detector 26. The user output interface 16, in this example, comprises a display 18 and an audio output device 20 such as an output jack or loudspeaker. The memory 14 stores computer program instructions 2 and also a first data structure 4 for recording movement data and a second data structure 6 for temporarily storing received movement data.

In this example, the electronic communications device 10 is a mobile cellular telephone and the communications interface 8 is a cellular radio transceiver. However, the invention finds application with any electronic device that has a hand portable component comprising a motion detector 26 and a mechanism for communicating with another device.

Only as many components are illustrated in the figure as are referred to in the following description. It should be appreciated that additional different components may be used in other embodiments of the invention. For example, although a programmable processor 12 is illustrated in FIG. 1 any appropriate controller may be used such as a dedicated processor e.g. an applications specific integrated circuit or similar.

The processor 12 is connected to read from and write to the memory 14, to provide control signals to the user output interface 16, to receive control signals from the user input interface 22 and to provide data to the communications interface 8 for transmission and to receive data from the communications interface 8 that has been received at the device 10.

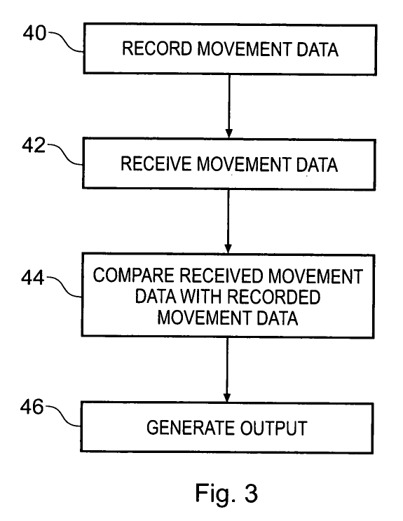

The computer program instructions 2 stored in the memory 14 control the operation of the electronic device 10 when loaded into the processor 12. The computer program instructions 2 provide the logic and routines that enable the electronic communications device 10 to perform the methods illustrated in FIGS. 2 and 3.

The computer program instructions may arrive at the electronic communications device 10 via an electromagnetic carrier signal or be copied from a physical entity 1 such as a computer program product, memory device or a record medium such as a CD-ROM or DVD.

The motion detector 26 may be any suitable motion detector. The motion detector 26 detects the motion of the device 10 and provides, as an output, movement data. The motion detector may, for example, measure six attributes namely acceleration in three orthogonal directions and orientation in three dimensions such as yaw, roll and pitch. Micro-electro-mechanical systems (MEMS) accelerometers, which are small and lightweight, may be used to detect acceleration.

FIG. 2 illustrates a first hand-portable communications device 10_{A} and a second hand-portable communications device 10_{B}. The first hand-portable communications device 10_{A} is moved M_{A} when a first user performs a gesture 30 with a hand holding the first hand-portable communications device 10_{A}. A gesture is a combination of different body movement, and in particular hand movements, that result in movement of the hand holding the device.

The second hand-portable communications device 10_{B} moves M_{B} when the user performs a gesture 34 with a hand holding the second hand-portable communications device 10_{B}.

The movement M_{A} is converted by the motion detector 26 in the first hand-portable communications device 10_{A} into first movement data that characterizes the movement M_{A} of the first hand-portable communications device 10_{A} when it is moved in the gesture 30. Likewise, the movement M_{B} of the second hand-portable communications device 10_{B} is converted by a motion detector 26 in the second hand-portable communications device 10_{B} into second movement data that characterizes the gesture 34.

The first hand-portable communications device 10_{A} sends the first movement data 32 to the second hand-portable communications device 10_{B} and the second hand-portable communications device 10_{B} sends the second movement data 36 to the first hand-portable communications device 10_{A}. Any suitable means may be used for this communication. For example the communication may occur by a low-power radio frequency transmissions such as that provided by Bluetooth (Trade Mark).

The process that occurs at a communications device 10 when movement data is received is illustrated in FIG. 3. The operation of FIG. 3 will now be described with reference to the first hand-portable communications device 10_{A}. However, it should also be appreciated that a symmetric process may occur at the second hand-portable communications device 10_{B}.

At the first hand-portable communications device 10_{A}, the first movement data 32 produced by the motion detector 26 when the gesture 30 is performed is stored in the data structure 4 in the memory 14, as illustrated in step 40 of FIG. 3.

Then at step 42, the second movement data 36 is received at the first hand-portable communications device 10_{A} and is temporarily stored as data structure 6 in the memory 14.

Then at step 44, the processor 12 reads the first data structure 4 (i.e. the first movement data 32) and the second data structure 6 (i.e. the second movement data 36) from the memory 14 and compares them. If the first movement data and the second movement data correspond within a threshold level of tolerance a match is declared. If, however, the first movement data 32 and the second movement data 36 do not correspond within the threshold level of tolerance, no match is declared. The process then moves to step 46 where an output is generated by the processor 12 through the user output interface 16. The nature of the output generated depends on whether a match or no match has been declared in step 44.

In one example, a first message is displayed on the display 18 when a match is declared and a second different message is displayed on the display 18 when no match is declared. Different first messages may be associated with different movement data. A group of persons may share a common first message which is displayed whenever members of the group greet each other with the same, appropriate gesture while holding the device 10.

In another example, a first audio output is created by the audio output device 20 when a match is declared and a second audio output is produced by the audio output device 20 when no match is declared. Different first audio outputs may be associated with different movement data. A group of persons may share a common first audio output which is played whenever members of the group greet each other with the same, appropriate gesture while holding the device 10.

The generated output may in addition or alternatively be transmitted to a number of users. For example, the movements M_{A} and M_{B} may represent a gesture that is shared amongst a group of individuals as a mutual greeting. The output generated at step 46, if a match is declared, may be a message that is sent to the individuals in that group. This message may for example give the identities of the first and second communication devices (or their users) and also their location.

In another example, if a match is declared, then the first hand-portable communications device 10_{A} is deemed to have positively authenticated the second hand-portable communications device 10_{B}. Such an authentication may be a necessary requirement for further transactions between the hand-portable communication devices 10.

In the example as illustrated in FIG. 2, the first and second communication devices are proximal to each other so that they may communicate via low power radio frequency transmissions. However, it is also possible for an embodiment of the invention to operate over much greater distances. In this example, the first movement data and the second movement data may be transmitted through a communication network such as the internet or a cellular telecommunications network. For example, a first and second movement data may be exchanged during a telephone conversation or via text messages, MMS messages, instant messages, email etc.

Although in the above example described in relation to FIG. 3, the recorded movement data 40 was generated in the first hand-portable device 10_{A}, in other embodiments, the first movement data may have been previously received at the first hand-portable communications device 10_{A}. The recorded movement data 40, when received from another device, may at the option of the user be associated with an entry in a contacts database for that another device and also, possibly, with other entries in the contacts database.

Although embodiments of the present invention have been described in the preceding paragraphs with reference to various examples, it should be appreciated that modifications to the examples given can be made without departing from the scope of the invention as claimed.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A device comprising:
an output device;
a memory for storing first device movement data;
a receiver for receiving second device movement data from another communications device; and
a processor operable to compare the stored first device movement data and the received second device movement data and to generate an output that depends upon the result of the comparison.

2. A device as claimed in claim 1, further comprising a transmitter for sending to the another communications device the first device movement data.

3. A device as claimed in claim 1, wherein the first device movement data characterises a hand gesture performed while holding a device.

4. A device as claimed in claim 1, further comprising one or more motion sensors, wherein the first device movement data is provided by the one or more motion sensors.

5. A device as claimed in claim 1, wherein the first device movement data is received at the device.

6. A device as claimed in claim 1, wherein the second device movement data characterises a hand gesture performed by a user of the another device while holding the another device.

7. A device as claimed in claim 1, wherein the output device comprises an audio output device and the generated output comprises an audio output from the audio output device.

8. A device as claimed in claim 1, wherein the output device comprises a visual output device and the generated output comprises a visual output from the visual output device.

9. A device as claimed in claim 1, wherein the output is an alert message for transmission to a plurality of destinations.

10. A device as claimed in claim 9, wherein the message for transmission includes location information.

11. A device as claimed in claim 9, wherein the message for transmission includes identification information identifying the device, or its user, and the another device, or its user.

12. A device as claimed in claim 11, wherein the reception of an alert message transmitted by a further device generates a programmed output.

13. A method comprising:
storing first device movement data;
receiving second device movement data;
comparing the first device movement data and the second device movement data;
and generating an output dependent upon the comparing step.

14. A method as claimed in claim 13, further comprising transmitting the first device movement data.

15. A method as claimed in claim 13, further comprising sensing motion of a first device to create the first device movement data.

16. A method as claimed in claim 15, wherein the first device movement data characterises a gesture performed while holding the first device.

17. A method as claimed in claim 16, wherein the second device movement data characterises a gesture performed by a user of a second device while holding the second device.

18. A method as claimed in claim 13, wherein the output generated includes an audio output.

19. A method as claimed in claim 13, wherein the output generated includes a visual output.

20. A method as claimed in claim 13, wherein the output generated includes transmission of a message to a plurality of destinations.

21. A method as claimed in claim 20, wherein the message includes location information.

22. A method as claimed in claim 21, wherein the message identifies a device at which the method of claim 13 is performed and a device to which the first device movement data is transmitted and from which the second device movement data is received.

23. A computer program product comprising computer program instructions for:
enabling storage of first device movement data;
comparing the first device movement data with received second device movement data; and
generating an output that depends upon the result of the comparison.
